(19) United States
(12) Patent Application Publication
(10) Pub. No.: US 2012/0000755 A1
(43) Pub. Date: Jan. 5, 2012

(54) ELECTRIC TOOL

(75) Inventors: Ryunosuke Kumagai, Anjo-shi (JP); Hidenori Nagasaka, Anjo-shi (JP); Tomonobu Nashimoto, Anjo-shi (JP)

(73) Assignee: MAKITA CORPORATION, Anjo-shi, Aichi (JP)

(21) Appl. No.: 13/203,915

(22) PCT Filed: Feb. 10, 2010
(86) PCT No.: PCT/JP2010/051945

§ 371 Date: Sep. 19, 2011

(30) Foreign Application Priority Data
Mar. 2, 2009 (JP) 2009-047806

(51) Int. Cl. H01H 9/02

(52) U.S. Cl. 200/293.1

(57) ABSTRACT

An auxiliary switch has an operation portion and a switch body switching on and off by receiving the movement of the operation portion, and the operation portion is mounted to a left side surface, a right side surface of the housing covering a region between the motor and the main switch, the switch body is accommodate within a space of the housing positioned on the left side and the right side of the man switch, and a space is defined between the motor and the main switch within the housing due to the spaced positioning of the left or right auxiliary switch.

### TECHNICAL FIELD

The present invention relates to an electric tool that has a housing including a tubular housing body for accommodating a motor, and a grip portion formed to protrude radially outwardly from the housing body; a trigger-type main switch disposed at a base end portion of the grip portion; and an auxiliary switch disposed adjacent to the main switch.

### BACKGROUND ART

A related electric tool is disclosed in Patent Document 1.

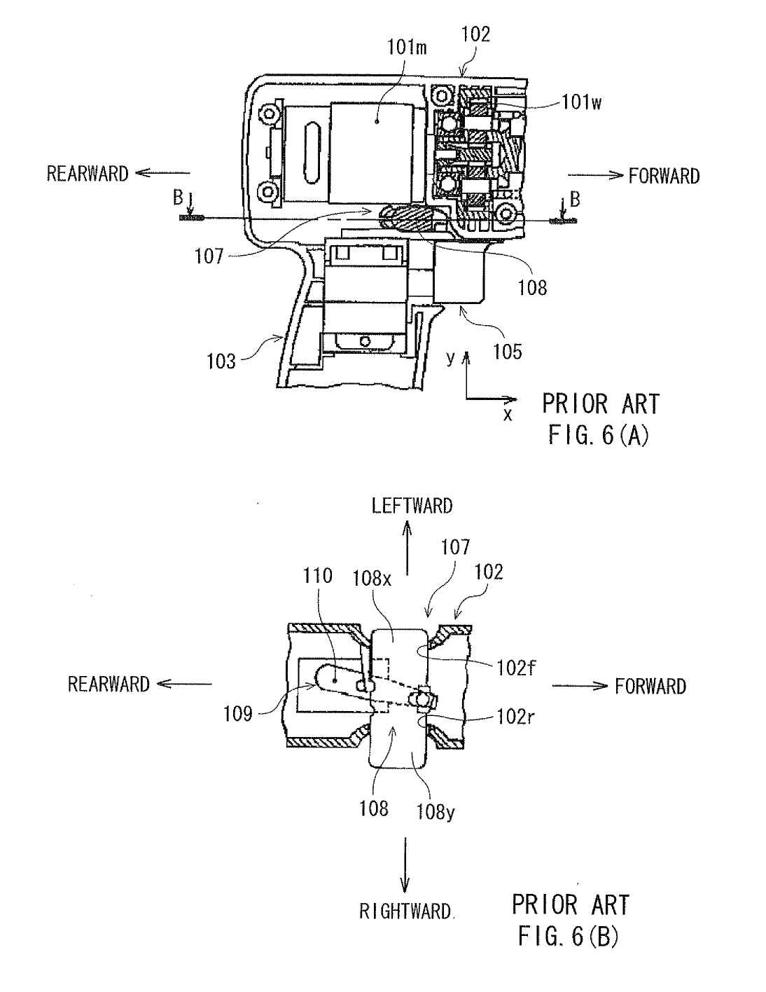

As shown in FIG. 6(A), the electric tool according to Patent Document 1 has a housing body 102 accommodating a motor 101n, a speed reduction device 101w, etc., and a trigger-type main switch 105 is disposed at a base end portion of a grip portion protruding radially outwardly from the housing body 102. And, a normal/reverse changing switch 107 for changing the rotational direction of the motor 101m is mounted at a position between the motor 101m and the main switch 105.

As shown in FIG. 6(B), the normal/reverse changing switch 107 is constituted by an operation lever 108 disposed to extend through the housing body 102 in the left and right direction, and a switch body portion 109 having an arm-like movable portion 110 connected to the operation lever 108. And, it is constructed such that the operation lever 107 moves rightward as a left push portion 108x of the operation lever 108 is pushed, and the operation lever 108 moves leftward as a right push portion 108y is pushed, whereby the movable portion 110 pivots rightward or leftward to change contacts of the switch body 109.

### PRIOR—ART DOCUMENTS

### Patent Documents

Patent Document 1: Japanese Laid-Open Patent Publication No. 05-301179 (Patent No. 2830602)

### SUMMARY OF THE INVENTION

### Problems to be Solved by the Invention

In the normal/reverse changing switch 107 of the electric tool described above, the operation lever 108 is disposed to extend through the housing body 102 in the left and right direction. Therefore, the normal/reverse changing switch 107 exclusively occupies a space between the motor 101 m and the main switch 105 within the housing body 102, and the space cannot accommodate the other components.

The present invention has been made to solve the above problem, and it is an object of the present invention to produce a new space by the change of the construction of an auxiliary switch, such as a normal/reverse changing switch, etc. thereby enabling effective use of a space within a housing.

### Means for Solving the Problems

The above problem can be solved by the inventions defined in the claims.

The invention according to claim 1 is an electric tool comprising a housing including a tubular housing body accommodating a motor, and a grip portion formed to protrude radially outward from the housing body; a trigger-type main switch disposed at a base end portion of the grip portion; and an auxiliary switch disposed adjacent to the main switch, characterized in that the auxiliary switch has an operation portion and a switch body switching on an off by receiving the movement of the operation portion; the operation portion of the auxiliary switch is mounted to a left side surface and/or a right side surface of the housing covering a region between the motor and the main switch, the switch body of the auxiliary switch is accommodate within a space of the housing positioned on the outer side in the left or right direction relative to the man switch, and a space is defined between the motor and the main switch within the housing due to the spaced positioning of the left or right auxiliary switch.

According to the present invention, the operation portion of the auxiliary switch is mounted to the left side surface and/or the right side surface of the housing covering a region between the motor and the main switch, and the switch body of the auxiliary switch is accommodate within a space of the housing positioned on the outer side in the left or right direction relative to the man switch. Therefore, for example, even in the case that the auxiliary switches are provided on both of right and left sides, a space is defined on the upper side of the main switch (between the main switch and the motor) because the left and right auxiliary switches are disposed on the outer side in the left and right directions relative to the main switch and are spaced from each other. Thus, a space is defined at a region that is occupied by the auxiliary switch in the prior art.

Therefore, it is possible to accommodate parts or the like in the space, enabling effective use of the space within the housing.

In the case that the auxiliary switch is disposed on either the left side or the right side of the housing, the space is defined on the upper side of the main switch (between the main switch and the motor) and on the side where no auxiliary switch is provided.

The invention according to claim 2 is characterized in that the auxiliary switch is a switch for changing the rotational direction of the motor.

The invention according to claim 3 is characterized in that a fan is disposed within the space between the motor and the main switch within the housing.

The fan cools the motor, which drives an end tool, or a motor drive circuit (FET, etc.). The invention according to claim 4 is characterized in that a noise inhibiting member is disposed within the space defined between the motor and the main switch within the housing.

The invention according to claim 5 is characterized in that there are provided a controller for controlling the motor based on a signal from the auxiliary switch, and a display that is lit when the controller operates based on the signal from the auxiliary switch.

Therefore, it can be known that the motor is performing a predetermined operation based on the signal of the auxiliary switch.

### Advantage of the Invention

According to the present invention, a new space is produced by the change of the construction of the auxiliary switch, so that the space within a housing can be effectively used.

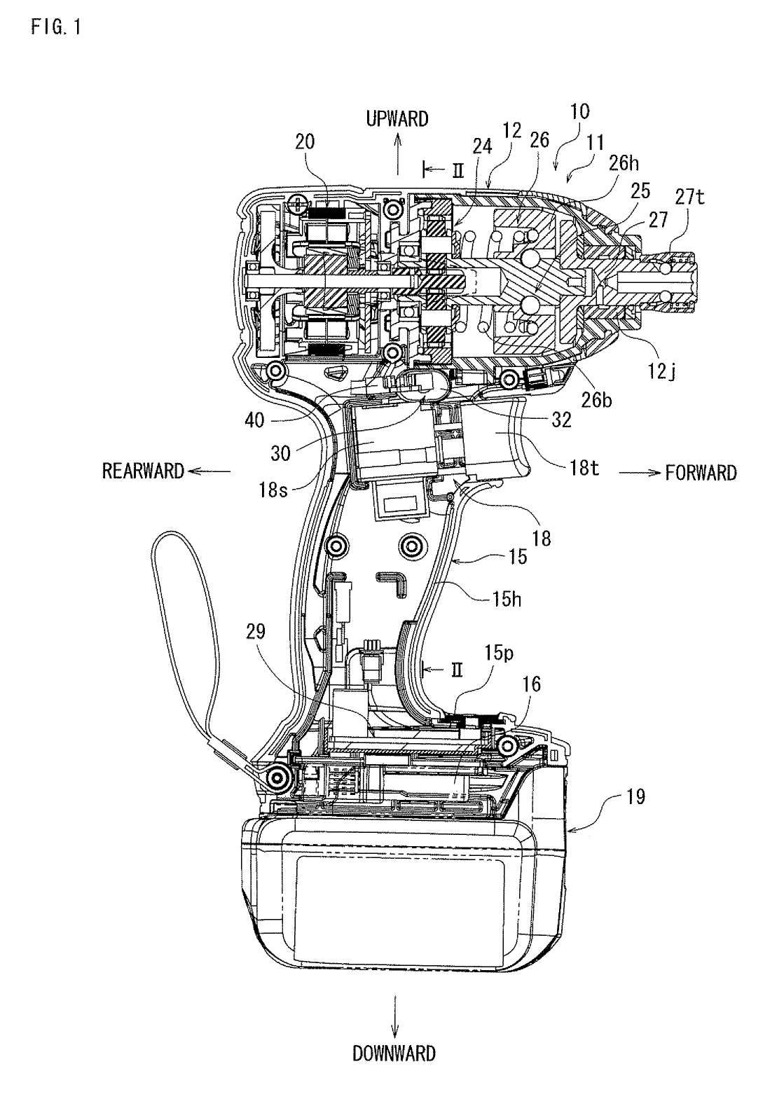

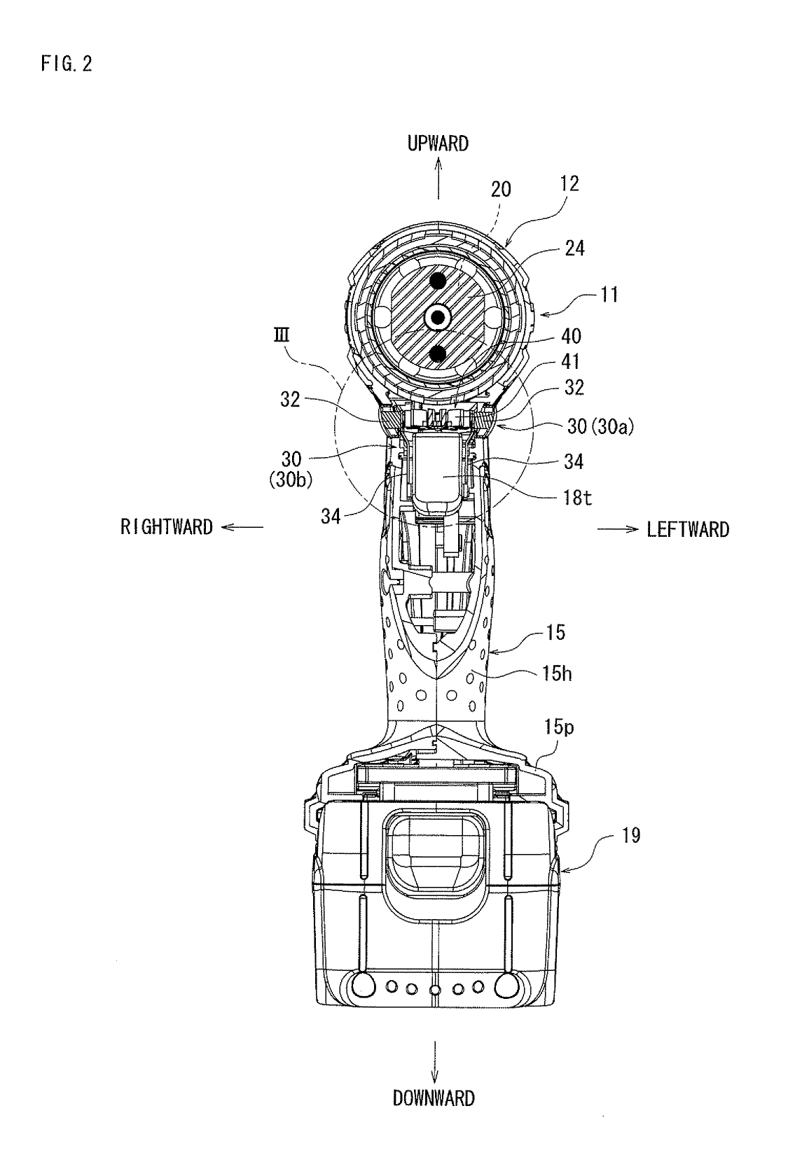

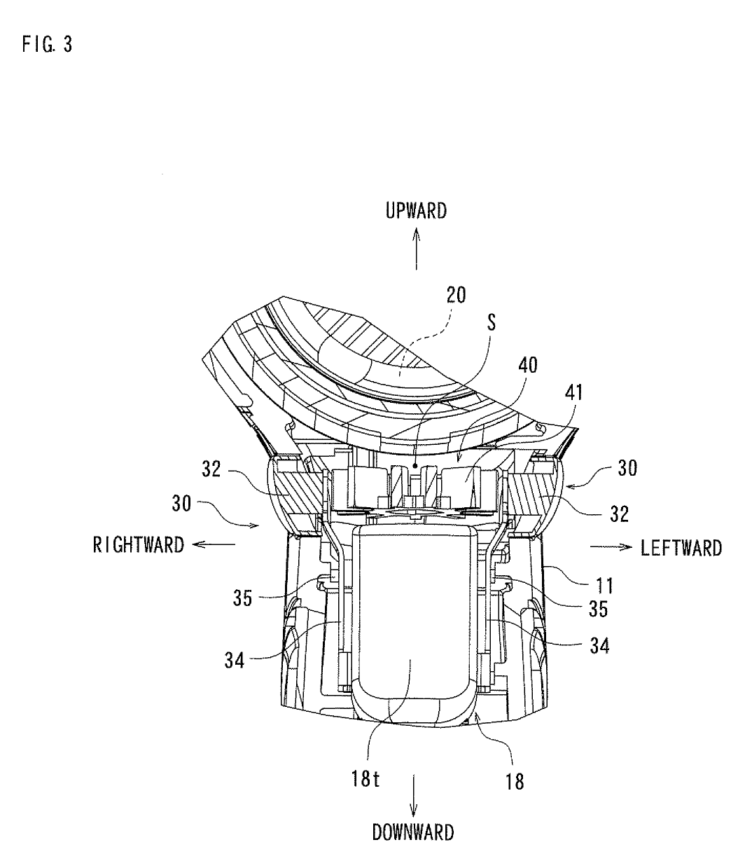

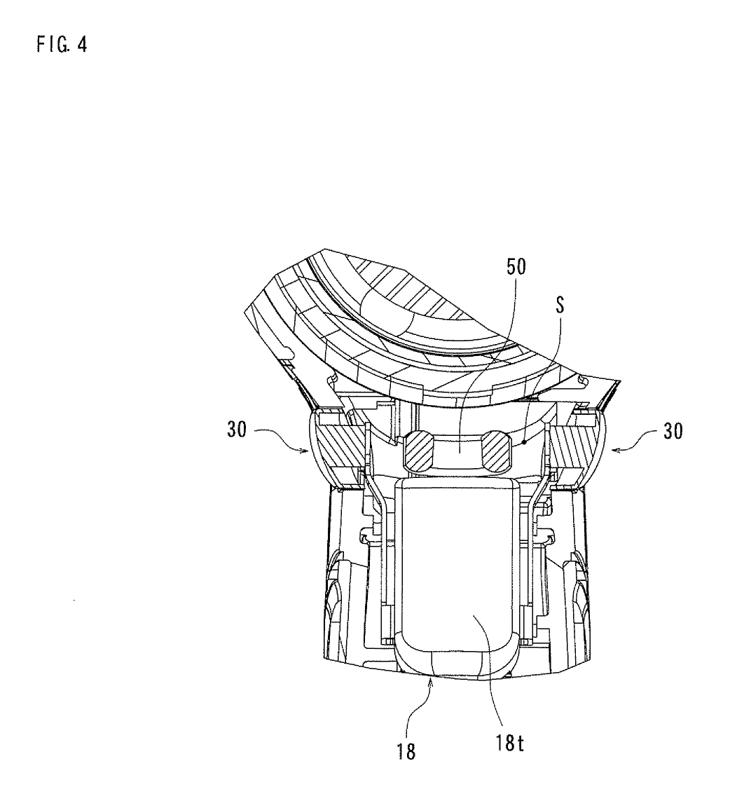

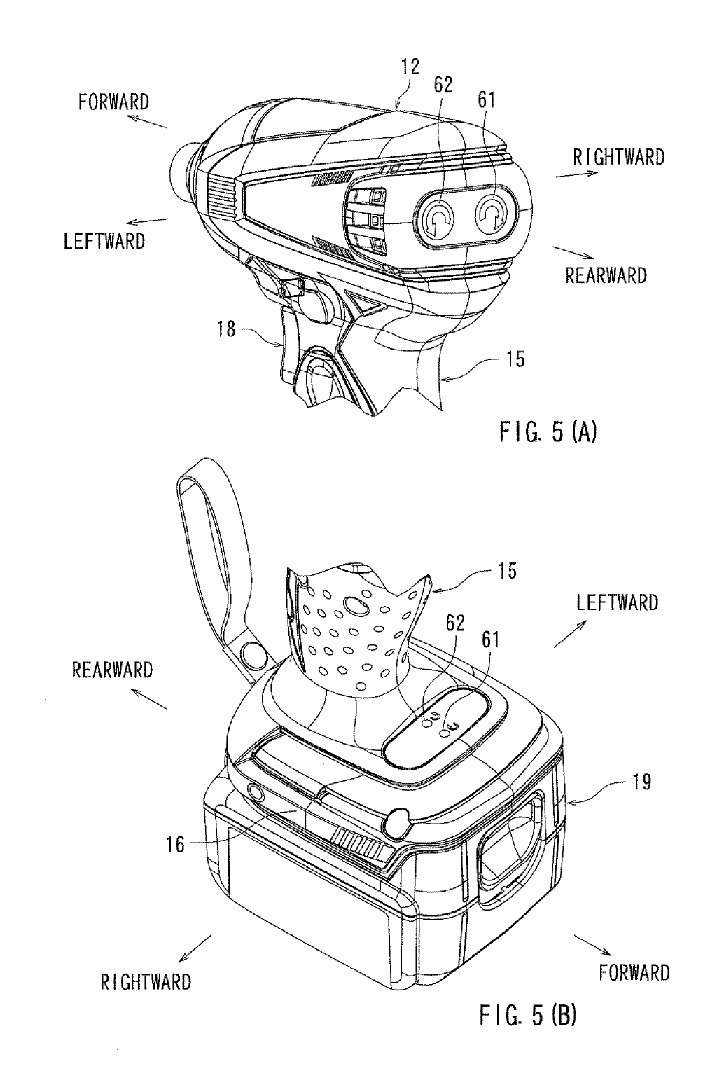

### BRIEF DESCRIPTION OF THE DRAWINGS

[FIG. 1] A vertical sectional view of an electric tool according to a first embodiment of the present invention.

[FIG. 2] A sectional view taken along arrow II-II.

[FIG. 3] An enlarged view of a portion of arrow III in FIG. 2.

[FIG. 4] An enlarged view of a portion of an electric tool according to an alternative embodiment.

[FIG. 5] Enlarged views of portions of electric tools according to alternative embodiments (FIG. A) (FIG. B).

[FIG. 6] A vertical sectional view showing an auxiliary switch of a conventional electric tool (FIG. A) and a horizontal sectional view showing a portion of the auxiliary switch (sectional view taken along arrow B-B in FIG. A) (FIG. B).

### MODE FOR CARRYING OUT THE INVENTION

### First Embodiment

An electric tool according to a first embodiment will be hereinafter described with reference to FIGS. 1 to 5. The electric tool according to this example is a rotary impact tool (impact driver) (hereinafter called “electric tool”) driven by a DC motor as a power source.

Here, forward, rearward, leftward, rightward, upward and downward in the figures correspond to forward, rearward, leftward, rightward, upward and downward with respect to the electric tool.

<Regarding Outline of Electric tool>

As shown in FIG. 1, a housing 11 of an electric tool 10 of the present embodiment is constituted by a tubular housing body 12 and a grip portion 15 formed to protrude from a lateral portion (lower portion as viewed in FIG. 1) of the housing body 12.

Within the housing body 12, a DC motor 20, a planetary gear mechanism 24, a spindle 25, an impact force generating mechanism 26 and an anvil 27 are coaxially accommodated in this order from the rear side. The DC motor 20 is a drive source of the electric tool 10, and the rotation of the DC motor 20 is transmitted to the spindle 25 after being reduced by the planetary gear mechanism 24. And, the rotational force of the spindle 25 is converted into a rotary impact force by the impact force generating mechanism 26 having a hammer 26h, a compression spring 26b, etc., and is then transmitted to the anvil 27. The anvil 27 is a portion rotating about an axis by receiving the rotary impact force and is supported by a bearing 12j mounted to the front end of the housing body 12, so that the anvil 27 can rotate about an axis but cannot move in an axial direction.

A chuck portion 27t is disposed at the front portion of the anvil 27 for mounting an end tool, such as a driver bit, socket bit, etc. (not shown).

The grip portion 15 of the housing 11 is a portion grasped by a user during the use of the electric tool 10 and is constituted by a grip part 15h and a lower end part 15p positioned on the side of the protruding end (lower end) relative to the grip part 15h. The grip part 15h is formed to have a relatively small diameter for enabling the user to easily grasp it, and a trigger-type main switch 18 is disposed at a based end portion of the grip part 15h. The main switch 18 includes a trigger portion 18t operated to be pulled by fingers of the user and includes a switch body portion 18s constructed such that a contact is switched on and off by the pulling operation of the trigger portion 18t and that a resistance value varies according to the pulling amount of the trigger portion 18t.

An output signal of the main switch 18 is inputted to a controller 29 accommodated within a lower portion of the grip portion 15. The controller 29 is constituted by a microcomputer, etc., mounted to a base plate, and controls a drive element (not shown) of the DC motor 20 based on the signal from the main switch 18.

The lower end part 15p of the grip portion 15 is constituted to be enlarged from the grip part 15h mainly in a direction forwardly on the lower side, and a battery pack connecting portion 16 for connecting a battery pack 19 is disposed on the lower side of the lower end part 15p. The battery pack connecting portion 16 is formed like an inverted recess having an inverted U-shape in cross section and is constituted such that a fitting portion (not shown) of the battery pack 19 is fitted into the battery pack connecting portion 15 as it is slid from the front side toward the rear side.

### <Regarding Normal/Reverse Changing Switch 30>

As shown in FIGS. 1 and 2, normal/reverse changing switches 30 are mounted to the housing 11 at a boundary position between the housing body 12 and the grip portion 15. The normal/reverse changing switches 30 are switches for changing the rotational direction of the DC motor 20 and are constituted, for example, by a normal rotation switch 30a positioned on the left side and a reverse rotation switch 30b positioned on the right side. Signals from the normal rotation switch 30a and the reverse rotation switch 30b are inputted to the controller 29. Thus, the controller 29 enables the DC motor 20 to rotate in the normal direction when the normal rotation switch 30 positioned on the left side is operated to be pushed, and the controller 29 enables the DC motor 20 to rotate in the reverse direction when the reverse rotation switch 30b positioned on the right side is operated to be pushed.

Here, the normal rotation switch 30a and the reverse rotation switch 30b are the same in construction, and therefore, the following explanation will be made by referring to the normal rotation switch 30a and the reverse rotation switch 30b as left and right normal/reverse changing switches 30, respectively.

As shown in an enlarged view of FIG. 3, the normal/reverse changing switch 30 is constituted by an operation button 32 operated to be pushed, and a switch body 34 and 35, in which a contact is switched on and off by receiving the movement of the operation button 32. As shown in FIGS. 1 and 2, the operation buttons 32 are mounted to the left side surface and the right side surface of the housing 11, which cover a region between the DC motor 20 and the trigger-type main switch 18. In addition, as shown in FIG. 3, the operation buttons 32 are constituted so as to be able to be pushed into inside of the housing 11 by a given distance and so as to be positioned on the outer side relative to the main switch 18 even in the state that the operation buttons 32 have been pushed by a maximum distance. Thus, the operation buttons 32 of the left and right normal/reverse changing switches 30 are positioned on the outer side relative to the main switch 18. Further, the switch bodies 34 and 35 of the left and right normal/reverse changing switches 30 are positioned on the lower side of their respective operation buttons 32 and on the outer side relative to the main switch 18.

Therefore, on the upper side of the trigger-type main switch 18, i.e., between the main switch 18 and the DC motor 20, a space S is defined due to separation of the left and right normal/reverse changing switch 30. And, a fan 40 having a built-in motor for driving a fan body 41 is accommodated within the space 5, and an end tool drive motor (DC motor 20) and a motor drive control circuit (FET, etc.) are cooled by the fan 40.

Thus, the normal/reverse changing switch 30 corresponds to an auxiliary switch of the present invention, and the operation button 32 corresponds to an operation portion for the auxiliary switch.

### <Advantages of Electric Tool 10 of the Present Embodiment>

According to the electric tool 10 of this example, the operation buttons 32 of the normal/reverse changing switches 30 are disposed at the left and right surfaces of the housing 11 covering the region between the DC motor 20 and the main switch 18. In addition, the switch bodies 34 and 35 of the normal/reverse changing switches 30 are positioned on the outer side in the left and right directions relative to the main switch 18. In this way, because the normal/reverse changing switches 30 are positioned on the outer side in the left and right directions relative to the main switch 18 and are spaced from each other, the space S is defined on the upper side of the main switch 18 (between the main switch 18 and the DC motor 20). Thus, the space S is defined in a region that was occupied by the normal/reverse changing switch in a known art. Therefore, it is possible to accommodate the fan 40, etc. within the space S, enabling effective use of the space within the housing 11.

### <Alternative Embodiments>

The present invention may not be limited to the above embodiment and may be modified within a range that does not depart from the gist of the present invention. For example, although an example of accommodating the fan 40 within the space S on the upper side (between the main switch 18 and the DC motor 20) has been described in the above embodiment, it is possible to accommodate within the space S a line filter 50 serving as a noise inhibiting member as shown in FIG. 4. It is also possible to accommodate a capacitor for inhibiting noise, etc.

Further, in the case of the electric tool 10 of the present embodiment, the DC motor 20 can rotate in the normal direction by pushing the left normal/reverse changing switch 30 and the DC motor can rotate in the reverse direction by pushing the right normal/reverse changing switch 30. However, the normal/reverse changing switch 30 may be positioned, for example, only on the left side, and may be switched such the normal rotation is enabled by one push, the reverse rotation is enabled by a once again push, and the normal rotation is enabled by a further push.

Further, as shown in FIG. 5(A), it may be possible to provide a normal rotation display 61 and a reverse rotation display 62 at the rear end position of the housing body 12 in order that the normal rotation display 61 is lit when the controller 29 has changed the rotational direction of the DC motor 20 to the normal rotational direction based on the signals from the normal/reverse changing switches 30, and the reverse rotation display 62 is lit when the controller 29 has changed to the reverse rotational direction. Here, it is possible to dispose the normal rotation display 61 and the reverse rotation display 62 at the lower end part 15p of the grip portion 15 as shown in FIG. 5(B).

Further, it may be possible to dispose the normal/reverse changing switch 30 on the left side and to dispose an auxiliary switch having the same construction on the right side in order to turn on and off an illumination light by the auxiliary switch. Thus, it may be possible to turn on by one push, turn off by a once again push, and turn on by a further push. Further, it may be possible to change the rotational seed of the DC motor 20 in a multistage by the auxiliary switch.

Furthermore, although an impact driver has been exemplified as the electric tool 10, it is possible to apply the present invention to a screwdriver, etc.

### DESCRIPTION OF REFERENCE NUMERALS

11 . . . housing

12 . . . housing body

15 . . . grip portion

18 . . . main switch

20 . . . DC motor

29 . . . controller

30 . . . normal/reverse changing switch (auxiliary switch)

32 . . . operation button (operation portion)

34, 35 . . . switch body

40 . . . fan

50 . . . line filter (noise inhibiting member)

61 . . . normal rotation display

62 . . . reverse rotation display

S . . . space

1-5. (canceled)

6. An electric tool comprising a housing including a tubular housing body accommodating a motor, and a grip portion formed to protrude radially outward from the housing body; a trigger-type main switch disposed at a base end portion of the grip portion; and an auxiliary switch disposed adjacent to the main switch, wherein:
the auxiliary switch has an operation portion and a switch body switching on an off by receiving the movement of the operation portion;
the operation portion of the auxiliary switch is mounted to one of a left side surface and a right side surface of the housing covering a region between the motor and the main switch;
the switch body of the auxiliary switch is accommodate within the housing at a position on the left or right side of the man switch; and
a space is defined between the motor, the main switch and the operation portion of the auxiliary switch within the housing.

7. The electric tool as defined in claim 6, wherein the auxiliary switch is operable to change the rotational direction of the motor.

8. The electric tool as defined in claim 6, wherein a fan is disposed within the space defined between the motor, the main switch and the operation portion of the auxiliary switch within the housing.

9. The electric tool as defined in claim 6, wherein a noise inhibiting member is disposed within the space defined between the motor, the main switch and the operation member of the auxiliary switch within the housing.

10. The electric tool as defined in claim 6, further comprising:
a controller for controlling the motor based on a signal from the auxiliary switch; and
a display that is lit when the controller operates based on the signal from the auxiliary switch.

11. An electric tool comprising a housing including a tubular housing body accommodating a motor, and a grip portion formed to protrude radially outward from the housing body; a trigger-type main switch disposed at a base end portion of the grip portion; and left and right auxiliary switches disposed adjacent to the main switch, wherein:
each of the left and right auxiliary switches has an operation portion and a switch body switching on an off by receiving the movement of the operation portion;
the operation portions of the left and right auxiliary switches are mounted to a left side surface and a right side surface, respectively, of the housing covering a region between the motor and the main switch;
the switch bodies of the left and right auxiliary switches are accommodate within the housing at positions on the left side and the right side of the main switch, respectively; and
a space is defined between the motor, the main switch and the operation portions of the left and right auxiliary switches within the housing.

12. The electric tool as defined in claim 11, wherein the left and right auxiliary switches are operable to change the rotational direction of the motor.

13. The electric tool as defined in claim 11, wherein a fan is disposed within the space defined between the motor, the main switch and the operations portions of the left and right auxiliary switches within the housing.

14. The electric tool as defined in claim 11, wherein a noise inhibiting member is disposed within the space defined between the motor, the main switch and the operation portions of the left and right auxiliary switches within the housing.

15. The electric tool as defined in claim 11, further comprising:
a controller for controlling the motor based on signals from the left and right auxiliary switches; and
first and second displays that are lit when the controller operates based on the signals from the left and right auxiliary switches, respectively.
